(19) United States
(12) Patent Application Publication
(10) Pub. No.: US 2005/0125266 A1
(43) Pub. Date: Jun. 9, 2005

(54) Method and system for boarding commercial airline flights

(75) Inventors: Arnold H. Bramnick, Boca Raton, FL (US); J. Kendall Burch, Cooper City, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/731,228

(22) Filed: Dec. 9, 2003

(51) Int. Cl. G06F 17/60

(52) U.S. Cl. 705/5

(57) ABSTRACT

A method for boarding a commercial airline flight can include determining denied boarding candidates for the flight. Passenger financial data is compared for the denied boarding candidates. A selection of passengers for the flight is made using the passenger financial data. A system for boarding a commercial airline flight is also disclosed.

### FIELD OF THE INVENTION

This invention relates generally to commercial airline operations and, more particularly, to systems and methods for boarding commercial airline flights.

### BACKGROUND OF THE INVENTION

Commercial airline passenger booking processes sometimes result in overbooking situations in which more passengers are scheduled for a flight than the number of seats that are available for that flight. The airline must then deny boarding to some passengers. In most instances, the airline issues a request for volunteers willing to miss the current flight. Various incentives are usually offered with the request, such as vouchers for free travel or for a monetary face value that can be applied toward the purchase of a future ticket. Depending upon the circumstances, the volunteer may also be awarded vouchers for a meal and a hotel. Other incentives may also be offered.

The number of volunteers sometimes exceeds the number of seats necessary to correct the overbooking situation. In this circumstance, volunteers are selected from the group of volunteers. This is usually accomplished on a first-come first-served basis in which the passengers who volunteered first are selected first as the passengers who will be re-accommodated on other flights and given the incentives. A first-come basis for selecting among volunteers is frequently financially sub-optimal for the airline such that the financial loss to the airline from the overbooking situation is made worse.

In other instances, there are insufficient volunteers to rectify the overbooking situation. In this instance, an involuntary denied boarding selection must be made. Selecting from among involuntary denied boarding candidates is also done by airlines in a financially sub-optimal way.

### SUMMARY OF THE INVENTION

A method for boarding a commercial airline flight can include determining denied boarding candidates for the flight. Passenger data can be compared for the denied boarding candidates. Passengers can be selected for the flight using the passenger data.

The passenger data can include the frequent flyer status of the passenger. Passenger data such as passenger financial data can be considered. For example, the remaining flight ticket value of each denied boarding candidate can be considered. The rebooking cost for each passenger can be considered, such as payments that may be required to another airline and the cost of meal and hotel reimbursements. The lifetime value for each passenger can be included in the passenger financial data. The passenger financial data can also include re-accommodation data. Re-accommodation data can specify whether another flight on the same airline is available, or whether the passenger must be re-accommodated on a competitor airline.

The comparing step can include the application of a set of rules to the passenger financial data. The rules can include the arranging of the denied boarding candidates according to descending revenue impact.

A system for boarding a commercial airline flight can include means for storing passenger data, including passenger financial data. Comparing means also can be provided for comparing the passenger data for denied boarding candidates and for selecting passengers for the flight from the denied boarding candidates according to the passenger data.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram of a system according to one embodiment of the invention.

FIG. 2 is a flow diagram illustrating a method according to another embodiment of the invention.

### DETAILED DESCRIPTION OF THE PREFERRED EMBODIMENTS

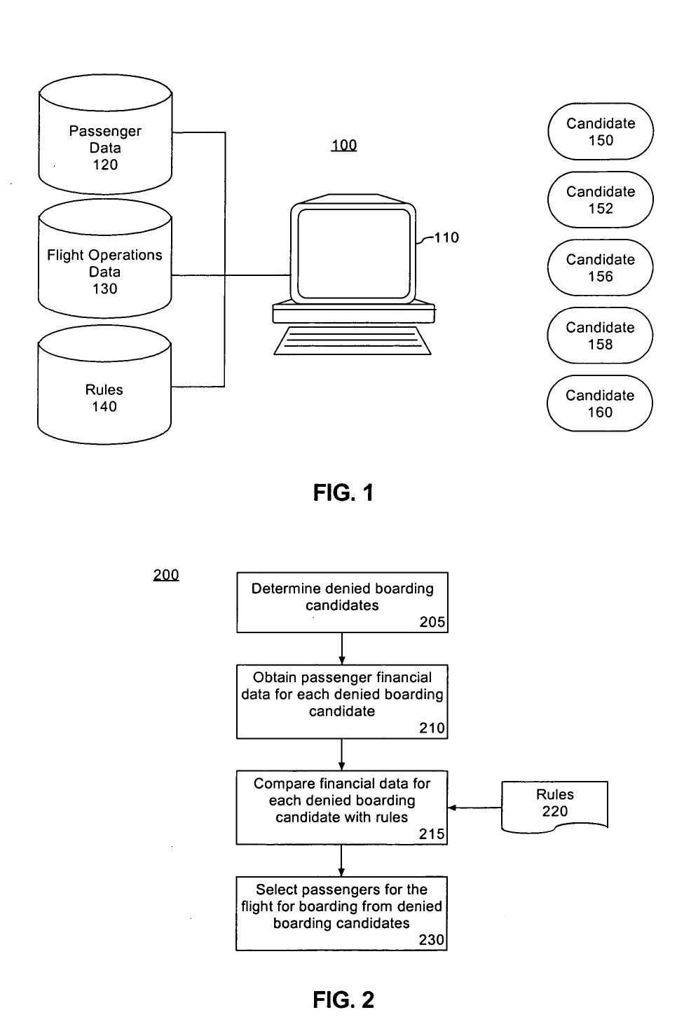

There is shown in FIG. 1 a system for boarding commercial airline flights in accordance with one embodiment of the invention. The system 100 can include an information processing system 110, passenger data 120, flight operations data 130, as well as rules 140 for processing the passenger data 120. The information processing system 110 can access the passenger data 120, flight operations data 130, as well as the rules 140. For example, the passenger data 120, the flight operations data 130, and the rules 140 each can be included within a suitable data store. Each data store can be linked with the information processing system 110 via suitable communications links.

In one embodiment of the present invention, the information processing system 110 can be a client system configured to access a server. The server can be configured to perform one or more of the functions described herein. For example, the information processing system 110 can be implemented as a dumb terminal. In another embodiment, the information processing system 110 can include processing capability. For example, the information processing system 110 can be a conventional computer system configured to perform one or more of the functions disclosed herein with or without the cooperation of a server.

The passenger data 120 can include any suitable passenger data. The passenger data 120 can include the frequent flyer status of the passenger. The airline may wish to accommodate the desire of a frequent flyer to volunteer. The passenger data 120 also can include passenger financial data. For example, passenger financial data can include the remaining flight ticket value for each passenger. A passenger having a high remaining ticket value may be denied the opportunity to volunteer, particularly if the result will be a less financially optimal flight for the airline or if the passenger must be re-accommodated on another airline. The rebooking cost for each passenger can be considered. The rebooking cost can include payments to other airlines if a passenger must travel on another airline, or the value of meals and hotel charges if rebooking of the passenger will involve an extended stay. The lifetime value of the passenger can also be considered. The airline may wish to accommodate the volunteer request of a passenger if the passenger has a history of purchasing profitable tickets for the airline, such as business class tickets. The passenger financial data can also include re-accommodation data which includes the availability of flights of the same airline, or whether the passenger must be re-accommodated on a competitor airline. The passenger financial data can also include Customer Relationship Management (CRM) data or other suitable data.

The flight operations data 130 can be any suitable flight operations data. The flight operations data 130 can include flight schedule and seat availability data on the airline and competitor airlines. Although the flight operations data 130 and passenger data 120 are shown as being located in separate data stores, the data can be combined into a single data store, or provided in a plurality of data stores. Further, the flight operations data 130, the passenger data 120, and the rules 140 can be stored within the information processing system 110 or can be remotely located from the information processing system 110.

As an example, consider that Flight 123 is likely to require 3-5 passengers to be denied boarding. The gate agents make an announcement to the passengers that the airline may need volunteers and offer incentives for volunteering. Five passengers 150-160 volunteer, as shown in FIG. 1. Ten minutes prior to departure, the agent cancels all outstanding reservations for non-boarded passengers and determines that three volunteers are needed. Passenger data 120 is accessed for each of the passengers 150-160. The passenger data 120 is compared using rules 140. The application of rules 140 results in the selection of three of the passengers from the five passengers 150-160, in a manner that is more financially optimal for the airline. It should be appreciated, however, that the present invention also can be used to determine which passengers will or will not be denied boarding in situations where no passengers have volunteered.

The rules 140 can be any suitable rules for selecting among passengers according to passenger data 120. In one aspect, the rules can require the selection of passengers according to the descending revenue impact on the airline. In another aspect, the rules can require selection based on the lifetime value of the passenger, which can be a valuation based upon factors such as frequent flyer status and/or average value of past ticket purchases. In another aspect, the rules can weigh various passenger financial data according to the preferences of the airline and select those passengers with the most favorable scores. Each of the aforementioned attributes, and combinations thereof, can be considered. Further, it should be appreciated that the rules can specify how raw data can be processed to determine one or more of the aforementioned valuation metrics if such information s not directly available from one of the data stores.

A method 200 in accordance with one embodiment of the invention is shown in FIG. 2. The method can begin in step 205 in which a group of denied boarding candidates is determined. In step 210, passenger data, which can include passenger financial data, for each of the denied boarding candidates is obtained. In step 215, the passenger data for each of the denied boarding candidates is compared according to rules 220. In step 230, passengers for the flight are selected for boarding from the denied boarding candidates. Those not selected can receive an incentive for having volunteered. The selections can be presented to a computer operator, such as an airline employee, through suitable operational software, for example flight booking and/or operational software.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suitable. A typical combination of hardware and software can be a general purpose computer system with a computer program that, when being loaded and executed, controls the computer system such that it carries out the methods described herein.

The present invention also can be embedded in a computer program product, which includes all the features enabling the implementation of the methods described herein, and which when loaded in a computer system is able to carry out the methods. Computer program in the present context means any expression, in any language, code or notation of a set of instructions intended to cause a system having an information processing capability to perform a particular function either directly or after either or both of the following: (a) conversion to another language, code or notation; or (b) reproduction in a different material form.

This invention can be embodied in other forms without departing from the spirit or essential attributes thereof and, accordingly, reference should be had to the following claims rather than the foregoing specification as indicating the scope of the invention.

1. A method for boarding a commercial airline flight, comprising the steps of:
determining denied boarding candidates for said flight;
comparing passenger data for said denied boarding candidates; and
selecting passengers for said flight using said passenger data.

2. The method of claim 1, wherein said passenger data comprises the frequent flyer status of the passenger.

3. The method of claim 1, wherein said passenger data is passenger financial data.

4. The method of claim 3, wherein said passenger financial data comprises the remaining flight ticket value of each denied boarding candidate.

5. The method of claim 3, wherein said passenger financial data comprises the rebooking cost of each passenger.

6. The method of claim 3, wherein said passenger financial data comprises passenger lifetime value data.

7. The method of claim 3, wherein said passenger financial data comprises re-accommodation data.

8. The method of claim 1, wherein said denied boarding candidates are volunteers.

9. The method of claim 1, wherein said denied boarding candidates are involuntary.

10. The method of claim 1, wherein said comparing step comprises the application of a set of rules.

11. The method of claim 10, wherein said rules comprise arranging said passengers according to a descending revenue impact to the airline.

12. The method of claim 10, wherein said rules comprise arranging said passengers according to passenger frequent flyer status.

13. The method of claim 10, wherein said rules require arranging said passengers according to passenger lifetime value data.

14. A system for boarding a commercial airline flight, comprising:
means for storing passenger data; and
comparing means for comparing passenger data for denied boarding candidates and for selecting passengers for said flight from said denied boarding candidates according to the passenger data.

15. The system of claim 14, wherein said passenger data is passenger financial data.

16. A machine readable storage having stored thereon a computer program having a plurality of code sections executable by a machine for causing the machine to perform the steps of:
determining denied boarding candidates for said flight;
comparing passenger data for said denied boarding candidates; and
selecting passengers for said flight using said passenger data.

17. The machine readable storage of claim 16, wherein said passenger data comprises the frequent flyer status of the passenger.

18. The machine readable storage of claim 16, wherein said passenger data is passenger financial data.

19. The machine readable storage of claim 18, wherein said passenger financial data comprises the remaining flight ticket value of each denied boarding candidate.

20. The machine readable storage of claim 18, wherein said passenger financial data comprises the rebooking cost of each passenger.

21. The machine readable storage of claim 18, wherein said passenger financial data comprises passenger lifetime value data.

22. The machine readable storage of claim 18, wherein said passenger financial data comprises re-accommodation data.

23. The machine readable storage of claim 16, wherein said comparing means comprises rules for making said comparison.

24. The machine readable storage of claim 23, wherein said rules comprise arranging said passengers according to a descending revenue impact to the airline.

25. The machine readable storage of claim 23, wherein said rules comprise arranging said passengers according to passenger frequent flyer status.

26. The machine readable storage of claim 23, wherein said rules require arranging said passengers according to passenger lifetime value data.
